(19) United States
(12) Patent Application Publication
(10) Pub. No.: US 2011/0110377 A1
(43) Pub. Date: May 12, 2011

(54) Employing Overlays for Securing Connections Across Networks

(75) Inventors: Hasan Alkhatib, Kirkland, WA (US); Deepak Bansal, Redmond, WA (US)

(73) Assignee: MICROSOFT CORPORATION, Redmond, WA (US)

(21) Appl. No.: 12/614,007

(22) Filed: Nov. 6, 2009

(51) Int. Cl. H04L 12/56

(52) U.S. Cl. 370/395.53

(57) ABSTRACT

Computerized methods, systems, and computer-storage media for establishing and managing a virtual network overlay (“overlay”) are provided. The overlay spans between a data center and a private enterprise network and includes endpoints, of a service application, that reside in each location. The service-application endpoints residing in the data center and in the enterprise private network are reachable by data packets at physical IP addresses. Virtual presences of the service-application endpoints are instantiated within the overlay by assigning the service-application endpoints respective virtual IP addresses and maintaining an association between the virtual IP addresses and the physical IP addresses. This association facilitates routing the data packets between the service-application endpoints, based on communications exchanged between their virtual presences within the overlay. Also, the association secures a connection between the service-application endpoints within the overlay that blocks communications from other endpoints without a virtual presence in the overlay.

### BACKGROUND

Large-scale networked systems are commonplace platforms employed in a variety of settings for running applications and maintaining data for business and operational functions. For instance, a data center (e.g., physical cloud computing infrastructure) may provide a variety of services (e.g., web applications, email services, search engine services, etc.) for a plurality of customers simultaneously. These large-scale networked systems typically include a large number of resources distributed throughout the data center, in which each resource resembles a physical machine or a virtual machine running on a physical host. When the data center hosts multiple tenants (e.g., customer programs), these resources are optimally allocated from the same data center to the different tenants.

Customers of the data center often require business applications running in a private enterprise network (e.g., server managed by a customer that is geographically remote from the data center) to interact with the software being run on the resources in the data center. Providing a secured connection between the private enterprise network and the resources generally involves establishing a physical partition within the data center that restricts other currently-running tenant programs from accessing the business applications. For instance, a hosting service provider may carve out a dedicated physical network from the data center, such that the dedicated physical network is set up as an extension of the enterprise private network. However, because the data center is constructed to dynamically increase or decrease the number of resources allocated to a particular customer (e.g., based on a processing load), it is not economically practical to carve out the dedicated physical network and statically assign the resources therein to an individual customer.

### SUMMARY

This Summary is provided to introduce concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention provide a mechanism to isolate endpoints of a customer's service application that is being run on a physical network. In embodiments, the physical network includes resources within an enterprise private network managed by the customer and virtual machines allocated to the customer within a data center that is provisioned within a cloud computing platform. Often, the data center may host many tenants, including the customer's service application, simultaneously. As such, isolation of the endpoints of the customer's service application is desirable for security purposes and is achieved by establishing a virtual network overlay (“overlay”). The overlay sets in place restrictions on who can communicate with the endpoints in the customer's service application in the data center.

In one embodiment, the overlay spans between the data center and the private enterprise network to include endpoints of the service application that reside in each location. By way of example, a first endpoint residing in the data center of the cloud computing platform, which is reachable by a first physical internet protocol (IP) address, is identified as a component of the service application. In addition, a second endpoint residing in one of the resources of the enterprise private network, which is reachable by a second physical IP address, is also identified as a component of the service application. Upon identifying the first and second endpoint, the virtual presences of the first endpoint and the second endpoint are instantiated within the overlay. In an exemplary embodiment, instantiating involves the steps of assigning the first endpoint a first virtual IP address, assigning the second endpoint a second virtual IP address, and maintaining an association between the physical IP addresses and the virtual IP addresses. This association facilitates routing packets between the first and second endpoints based on communications exchanged between their virtual presences within the overlay.

Further, this association precludes endpoints of the other applications from communicating with those endpoints instantiated in the overlay. But, in some instances, the preclusion of other application's endpoints does not preclude federation between individual overlays. By way of example, endpoints or other resources that reside in separate overlays can communicate with each other via a gateway, if established. The establishment of the gateway may be controlled by an access control policy, as more fully discussed below.

Even further, the overlay makes visible to endpoints within the data center those endpoints that reside in networks (e.g., the private enterprise network) that are remote from the data center, and allows the remote endpoints and data-center endpoints to communicate as internet protocol (IP)-level peers. Accordingly, the overlay allows for secured, seamless connection between the endpoints of the private enterprise network and the data center, while substantially reducing the shortcomings (discussed above) inherent in carving out a dedicated physical network within the data center. That is, in one embodiment, although endpoints and other resources may be geographically distributed and may reside in separate private networks, the endpoints and other resources appear as if they are on a single network and are allowed to communicate as if they resided on a single private network.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing embodiments of the present invention;

FIG. 2 is a block diagram illustrating an exemplary cloud computing platform, suitable for use in implementing embodiments of the present invention, that is configured to allocate virtual machines within a data center;

FIG. 3 is block diagram of an exemplary distributed computing environment with a virtual network overlay established therein, in accordance with an embodiment of the present invention;

FIG. 4 is a schematic depiction of a secured connection within the virtual network overlay, in accordance with an embodiment of the present invention;

FIGS. 5-7 are block diagrams of exemplary distributed computing environments with virtual network overlays established therein, in accordance with embodiments of the present invention;

FIG. 8 is a schematic depiction of a plurality of overlapping ranges of physical internet protocol (IP) addresses and a nonoverlapping range of virtual IP addresses, in accordance with an embodiment of the present invention;

FIG. 9 is a flow diagram showing a method for communicating across a virtual network overlay between a plurality of endpoints residing in distinct locations within a physical network, in accordance with an embodiment of the present invention; and

FIG. 10 is a flow diagram showing a method for facilitating communication between a source endpoint and a destination endpoint across a virtual network overlay, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods, computer systems, and computer-readable media for automatically establishing and managing a virtual network overlay (“overlay”). In one aspect, embodiments of the present invention relate to one or more computer-readable media having computer-executable instructions embodied thereon that, when executed, perform a method for communicating across a virtual network overlay between a plurality of endpoints residing in distinct locations within a physical network. In one instance, the method involves identifying a first endpoint residing in a data center of a cloud computing platform and identifying a second endpoint residing in a resource of an enterprise private network. Typically, the first endpoint is reachable by a packet of data at a first physical internet protocol (IP) address and the second endpoint is reachable at a second physical IP address.

The method may further involve instantiating virtual presences of the first endpoint and the second endpoint within the virtual network overlay established for a service application. In an exemplary embodiment, instantiating includes one or more of the following steps: (a) assigning the first endpoint a first virtual IP address; (b) maintaining in a map an association between the first physical IP address and the first virtual IP address; (c) assigning the second endpoint a second virtual IP address; and (d) maintaining in the map an association between the second physical IP address and the second virtual IP address. In operation, the map may be utilized to route packets between the first endpoint and the second endpoint based on communications exchanged between the virtual presences within the virtual network overlay. In an exemplary embodiment, as a precursor to instantiation, the first endpoint and/or the second endpoint may authenticated to ensure they are authorized to join the overlay. Accordingly, the overlay is provisioned with tools to exclude endpoints that are not part of the service application and to maintain a high level of security during execution of the service application. Specific embodiments of these authentication tools are described more fully below.

In another aspect, embodiments of the present invention relate to a computer system for instantiating in a virtual network overlay a virtual presence of a candidate endpoint residing in a physical network. Initially, the computer system includes, at least, a data center and a hosting name server. In embodiments, the data center is located within a cloud computing platform and is configured to host the candidate endpoint. As mentioned above, the candidate endpoint often has a physical IP address assigned thereto. The hosting name server is configured to identify a range of virtual IP addresses assigned to the virtual network overlay. Upon identifying the range, the hosting name server assigns to the candidate endpoint a virtual IP address that is selected from the range. A map may be maintained by the hosting name server, or any other computing device within the computer system, that persists the assigned virtual IP address in association with the physical IP address of the candidate endpoint.

In yet another aspect, embodiments of the present invention relate to a computerized method for facilitating communication between a source endpoint and a destination endpoint across the virtual network overlay. In one embodiment, the method involves binding a source virtual IP address to a source physical IP address in a map and binding a destination virtual IP address to a destination physical IP address in the map. Typically, the source physical IP address indicates a location of the source endpoint within a data center of a cloud computing platform, while the destination physical IP address indicates a location of the destination endpoint within a resource of an enterprise private network. The method may further involve sending a packet from the source endpoint to the destination endpoint utilizing the virtual network overlay. Generally, the source virtual IP address and the destination virtual IP address indicate a virtual presence of the source endpoint and the destination endpoint, respectively, in the virtual network overlay. In an exemplary embodiment, sending the packet includes one or more of the following steps: (a) identifying the packet that is designated to be delivered to the destination virtual IP address; (b) employing the map to adjust the designation from the destination virtual IP address to the destination physical IP address; and (c) based on the destination physical IP address, routing the packet to the destination endpoint within the resource.

Having briefly described an overview of embodiments of the present invention, an exemplary operating environment suitable for implementing embodiments of the present invention is described below.

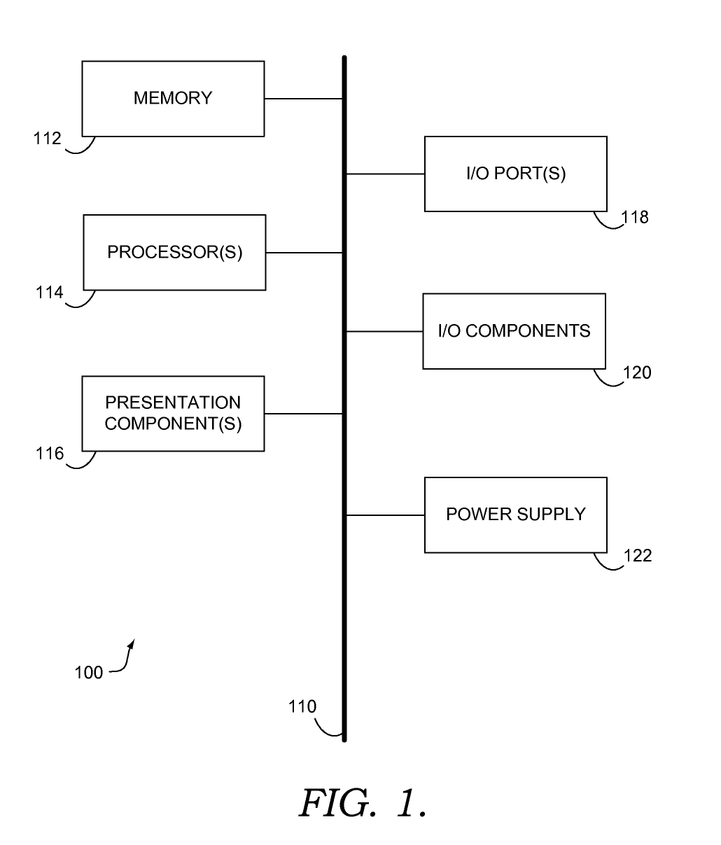

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing environment 100 be interpreted as having any dependency or requirement relating to any one or combination of components illustrated.

Embodiments of the present invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like refer to code that performs particular tasks, or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built-in. Illustrative components include a microphone, joystick, game pad, satellite dish, scanner, printer, wireless device, etc.

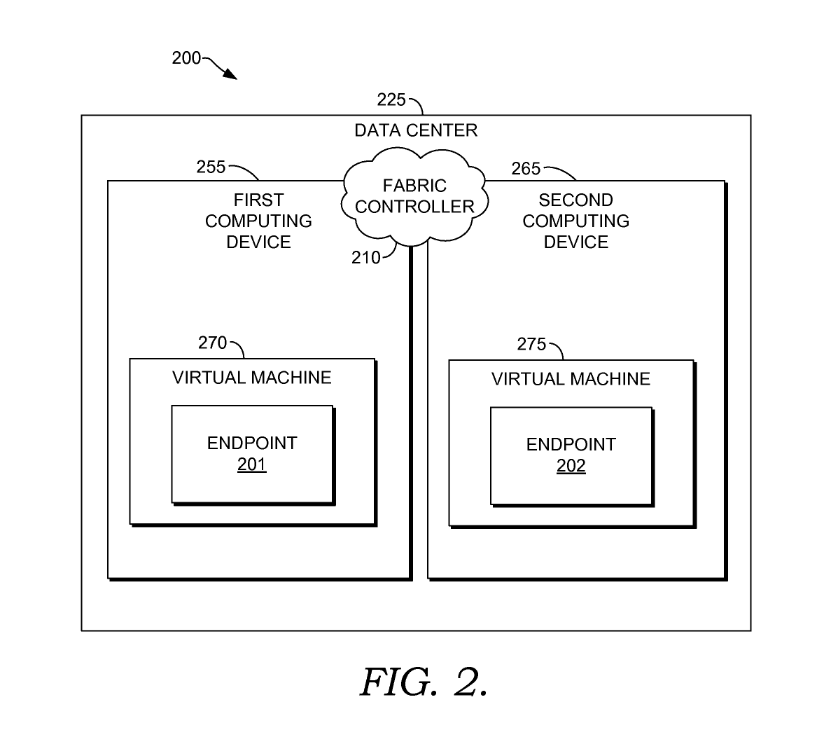

With reference to FIGS. 1 and 2, a first computing device 255 and/or second computing device 265 may be implemented by the exemplary computing device 100 of FIG. 1. Further, endpoint 201 and/or endpoint 202 may include portions of the memory 112 of FIG. 1 and/or portions of the processors 114 of FIG. 1.

Turning now to FIG. 2, a block diagram is illustrated, in accordance with an embodiment of the present invention, showing an exemplary cloud computing platform 200 that is configured to allocate virtual machines 270 and 275 within a data center 225 for use by a service application. It will be understood and appreciated that the cloud computing platform 200 shown in FIG. 2 is merely an example of one suitable computing system environment and is not intended to suggest any limitation as to the scope of use or functionality of embodiments of the present invention. For instance, the cloud computing platform 200 may be a public cloud, a private cloud, or a dedicated cloud. Neither should the cloud computing platform 200 be interpreted as having any dependency or requirement related to any single component or combination of components illustrated therein. Further, although the various blocks of FIG. 2 are shown with lines for the sake of clarity, in reality, delineating various components is not so clear, and metaphorically, the lines would more accurately be grey and fuzzy. In addition, any number of physical machines, virtual machines, data centers, endpoints, or combinations thereof may be employed to achieve the desired functionality within the scope of embodiments of the present invention.

The cloud computing platform 200 includes the data center 225 configured to host and support operation of endpoints 201 and 202 of a particular service application. The phrase “service application,” as used herein, broadly refers to any software, or portions of software, that runs on top of, or accesses storage locations within, the data center 225. In one embodiment, one or more of the endpoints 201 and 202 may represent the portions of software, component programs, or instances of roles that participate in the service application. In another embodiment, one or more of the endpoints 201 and 202 may represent stored data that is accessible to the service application. It will be understood and appreciated that the endpoints 201 and 202 shown in FIG. 2 are merely an example of suitable parts to support the service application and are not intended to suggest any limitation as to the scope of use or functionality of embodiments of the present invention.

Generally, virtual machines 270 and 275 are allocated to the endpoints 201 and 202 of the service application based on demands (e.g., amount of processing load) placed on the service application. As used herein, the phrase “virtual machine” is not meant to be limiting, and may refer to any software, application, operating system, or program that is executed by a processing unit to underlie the functionality of the endpoints 201 and 202. Further, the virtual machines 270 and 275 may include processing capacity, storage locations, and other assets within the data center 225 to properly support the endpoints 201 and 202.

In operation, the virtual machines 270 and 275 are dynamically allocated within resources (e.g., first computing device 255 and second computing device 265) of the data center 225, and endpoints (e.g., the endpoints 201 and 202) are dynamically placed on the allocated virtual machines 270 and 275 to satisfy the current processing load. In one instance, a fabric controller 210 is responsible for automatically allocating the virtual machines 270 and 275 and for placing the endpoints 201 and 202 within the data center 225. By way of example, the fabric controller 210 may rely on a service model (e.g., designed by a customer that owns the service application) to provide guidance on how and when to allocate the virtual machines 270 and 275 and to place the endpoints 201 and 202 thereon.

As discussed above, the virtual machines 270 and 275 may be dynamically allocated within the first computing device 255 and second computing device 265. Per embodiments of the present invention, the computing devices 255 and 265 represent any form of computing devices, such as, for example, a personal computer, a desktop computer, a laptop computer, a mobile device, a consumer electronic device, server(s), the computing device 100 of FIG. 1, and the like. In one instance, the computing devices 255 and 265 host and support the operations of the virtual machines 270 and 275, while simultaneously hosting other virtual machines carved out for supporting other tenants of the data center 225, where the tenants include endpoints of other service applications owned by different customers.

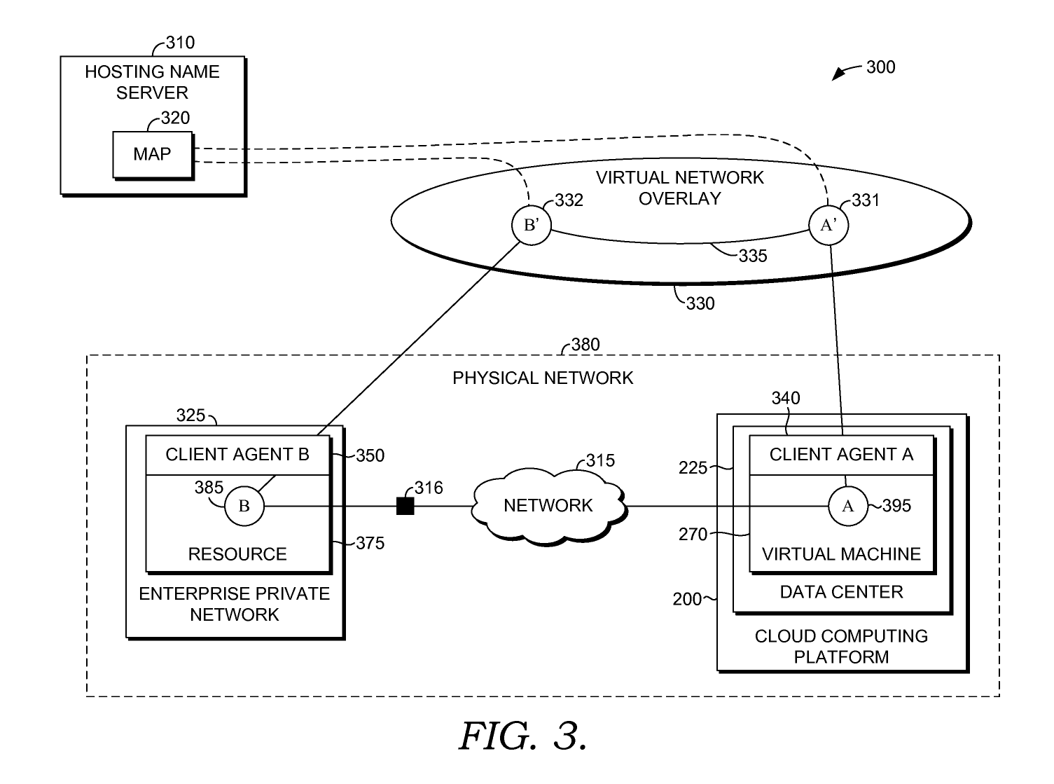

In one aspect, the endpoints 201 and 202 operate within the context of the cloud computing platform 200 and, accordingly, communicate internally through connections dynamically made between the virtual machines 270 and 275, and externally through a physical network topology to resources of a remote network (e.g., in FIG. 3 resource 375 of the enterprise private network 325). The internal connections may involve interconnecting the virtual machines 270 and 275, distributed across physical resources of the data center 225, via a network cloud (not shown). The network cloud interconnects these resources such that the endpoint 201 may recognize a location of the endpoint 202, and other endpoints, in order to establish a communication therebetween. In addition, the network cloud may establish this communication over channels connecting the endpoints 201 and 202 of the service application. By way of example, the channels may include, without limitation, one or more local area networks (LANs) and/or wide area networks (WANs). Such networking environments are commonplace in offices, enterprise-wide computer networks, intranets, and the Internet. Accordingly, the network is not further described herein.

Turning now to FIG. 3, block diagram illustrating an exemplary distributed computing environment 300, with a virtual network overlay 330 established therein, is shown in accordance with an embodiment of the present invention. Initially, the distributed computing environment 300 includes a hosting name server 310 and physical network 380 that includes an enterprise private network 325 and a cloud computing platform 200, as discussed with reference to FIG. 2. As used herein, the phrase “physical network” is not meant to be limiting, but may encompass tangible mechanisms and equipment (e.g., fiber lines, circuit boxes, switches, antennas, IP routers, and the like), as well as intangible communications and carrier waves, that facilitate communication between endpoints at geographically remote locations. By way of example, the physical network 380 may include any wired or wireless technology utilized within the Internet, or available for promoting communication between disparate networks.

Generally, the enterprise private network 325 includes resources, such as resource 375, that are managed by a customer of the cloud computing platform 200. Often, these resources host and support operations of components of the service application owned by the customer. Endpoint B 385 represents one or more of the components of the service application. In embodiments, resources, such the virtual machine 270 of FIG. 2, are allocated within the data center 225 of FIG. 2 to host and support operations of remotely distributed components of the service application. Endpoint A 395 represents one or more of these remotely distributed components of the service application. In operation, the endpoints A 395 and B 385 work in concert with each other to ensure the service application runs properly. In one instance, working in concert involves transmitting between the endpoints A 395 and B 385 a packet 316 of data across a network 315 of the physical network 380.

Typically, the resource 375, the hosting name server 310, and the data center 225 include, or are linked to, some form of a computing unit (e.g., central processing unit, microprocessor, etc.) to support operations of the endpoint(s) and/or component(s) running thereon. As utilized herein, the phrase “computing unit” generally refers to a dedicated computing device with processing power and storage memory, which supports one or more operating systems or other underlying software. In one instance, the computing unit is configured with tangible hardware elements, or machines, that are integral, or operably coupled, to the resource 375, the hosting name server 310, and the data center 225 to enable each device to perform a variety of processes and operations. In another instance, the computing unit may encompass a processor (not shown) coupled to the computer-readable medium accommodated by each of the resource 375, the hosting name server 310, and the data center 225. Generally, the computer-readable medium stores, at least temporarily, a plurality of computer software components (e.g., the endpoints A 395 and B 385) that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

The virtual network overlay 330 (“overlay 330”) is typically established for a single service application, such as the service application that includes the endpoints A 395 and B 385, in order to promote and secure communication between the endpoints of the service application. Generally, the overlay 330 represents a layer of virtual IP addresses, instead of physical IP addresses, that virtually represents the endpoints of the service applications and connects the virtual representations in a secured manner. In other embodiments, the overlay 330 is a virtual network built on top of the physical network 380 that includes the resources allocated to the customer controlling the service application. In operation, the overlay 330 maintains one or more logical associations of the interconnected end points A 395 and B 385 and enforces the access control/security associated with the end points A 395 and B 385 required to achieve physical network reachability (e.g., using a physical transport).

The establishment of the overlay 330 will now be discussed with reference to FIG. 3. Initially, the endpoint A 395 residing in the data center 225 of the cloud computing platform 200 is identified by as being a component of a particular service application. The endpoint A 395 may be reachable over the network 315 of the physical network 380 at a first physical IP address. When incorporated into the overlay 330, the endpoint A 395 is assigned a first virtual IP address that locates a virtual presence A′ 331 of the endpoint A 395 within the overlay 330. The first physical IP address and the first virtual IP address may be bound and maintained within a map 320.

In addition, the endpoint B 385 residing in the resource 375 of the enterprise private network 325 may be identified by as being a component of a particular service application. The endpoint B 385 may be reachable over the network 315 of the physical network 380 at a second physical IP address. When incorporated into the overlay 330, the endpoint B 385 is assigned a second virtual IP address that locates a virtual presence B′ 332 of the endpoint B 385 within the overlay 330. The second physical IP address and the second virtual IP address may be bound and maintained within the map 320. As used herein, the term “map” is not meant to be limiting, but may comprise any mechanism for writing and/or persisting a value in association with another value. By way of example, the map 320 may simply refer to a table that records address entries stored in association with other address entries. As depicted, the map is maintained on and is accessible by the hosting name server 310. Alternatively, the map 320 may be located in any computing device connected to or reachable by the physical network 380 and is not restricted to the single instance, as shown in FIG. 3. In operation, the map 320 is thus utilized to route the packet 316 between the endpoints A 395 and B 385 based on communications exchanged between the virtual presences A′ 331 and B′ 332 within the overlay 330. By way of example, the map 320 is utilized in the following manner: the client agent A 340 detects a communication to the endpoint A 395 across the overlay 330; upon detection, the client agent A 395 access the map 320 to translate a physical IP address from the virtual IP address that originated the communication; and providing a response to the communication by directing the response to the physical IP address.

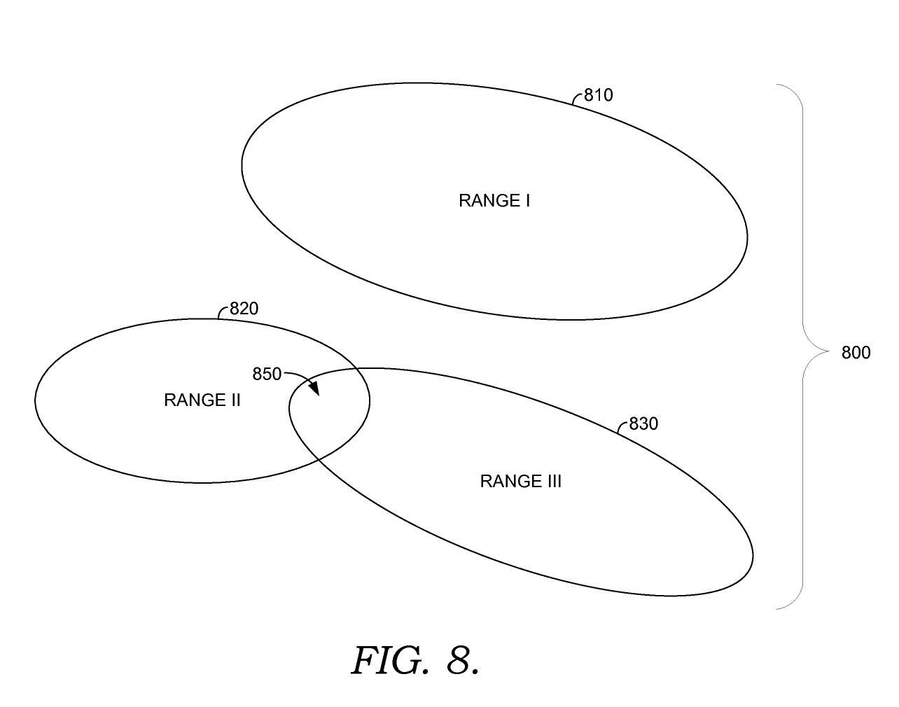

In embodiments, the hosting name server 310 is responsible for assigning the virtual IP addresses when instantiating the virtual presences A′ 331 and B′ 332 of the endpoints A 395 and B 385. The process of instantiating further includes assigning the overlay 330 a range of virtual IP addresses that enable functionality of the overlay 330. In an exemplary embodiment, the range of virtual IP addresses includes an address space that does not conflict or intersect with the address space of either the enterprise private network 325 or the cloud computing network 200. In particular, the range of virtual IP addresses assigned to the overlay 330 does not include addresses that match the first and second physical IP addresses of the endpoints A 395 and B 385, respectively. The selection of the virtual IP address range will be discussed more fully below with reference to FIG. 8.

Upon selection of the virtual IP address range, the process of instantiating includes joining the endpoints A 395 and B 385 as members of a group of endpoints that are employed as components of the service application. Typically, all members of the group of endpoints may be identified as being associated with the service application within the map 320. In one instance, the endpoints A 395 and B 385 are joined as members of the group of endpoints upon the service application requesting additional components to support the operation thereof. In another instance, joining may involve inspecting a service model associated with the service application, allocating the virtual machine 270 within the data center 225 of the cloud computing platform 200 in accordance with the service model, and deploying the endpoint A 395 on the virtual machine 270. In embodiments, the service model governs which virtual machines within the data center 225 are allocated to support operations of the service application. Further, the service model may act as an interface blueprint that provides instructions for managing the endpoints of the service application that reside in the cloud computing platform 200.

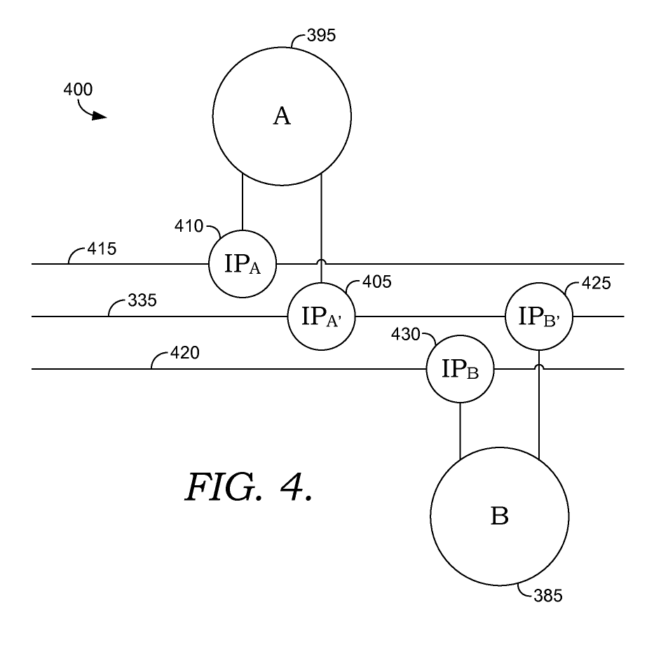

Once instantiated, the virtual presences A′ 331 and B′ 332 of the endpoints A 395 and B 385 may communicate over a secured connection 335 within the overlay 330. This secured connection 335 will now be discussed with reference to FIG. 4. As shown, FIG. 4 is a schematic depiction of the secured connection 335 within the overlay 330, in accordance with an embodiment of the present invention. Initially, endpoint A 395 is associated with a physical IP address IPA 410 and a virtual IP address IPA′ 405 within the overlay 330 of FIG. 3. The physical IP address IPA 410 is reachable over a channel 415 within a topology of a physical network. In contrast, the virtual IP address IPA′ 405 communicates across the secured connection 335 to a virtual IP address IPB′ 425 associated with the endpoint B 385. Additionally, the endpoint B 385 is associated with a physical IP address IPB 430. The physical IP address IPB 430 is reachable over a channel 420 within the topology of the physical network.

In operation, the overlay 330 enables complete connectivity between the endpoints A 395 and B 385 via the secured connection 335 from the virtual IP address IPA′ 405 to the virtual IP address IPB′ 425. In embodiments, “complete connectivity” generally refers to representing endpoints and other resources, and allowing them to communicate, as if they are on a single network, even when the endpoints and other resources may be geographically distributed and may reside in separate private networks.

Further, the overlay 330 enables complete connectivity between the endpoints A 395, B 385, and other members of the group of endpoints associated with the service application. By way of example, the complete connectivity allows the endpoints of the group to interact in a peer-to-peer relationship, as if granted their own dedicated physical network carved out of a data center. As such, the secured connection 335 provides seamless IP-level connectivity for the group of endpoints of the service application when distributed across different networks, where the endpoints in the group appear to each other to be connected in an IP subnet. In this way, no modifications to legacy, IP-based service applications are necessary to enable these service applications to communicate over different networks.

In addition, the overlay 330 serves as an ad-hoc boundary around a group of endpoints that are members of the service application. For instance, the overlay 330 creates secured connections between the virtual IP addresses of the group of endpoints, such as the secured connection 335 between the virtual IP address IPA′ 405 and the virtual IP address IPB′ 425. These secured connections are enforced by the map 320 and ensure the endpoints of the group are unreachable by others in the physical network unless provisioned as a member. By way of example, securing the connections between the virtual IP addresses of the group includes authenticating endpoints upon sending or receiving communications across the overlay 330. Authenticating, by checking a physical IP address or other indicia of the endpoints, ensures that only those endpoints that are pre-authorized as part of the service application can send or receive communications on the overlay 330. If an endpoint that is attempting to send or receive a communication across the overlay 330 is not pre-authorized to do so, the non-authorized endpoint will be unreachable by those endpoints in the group.

Returning to FIG. 3, the communication between the endpoints A 395 and B 385 will now be discussed with reference to client agent A 340 and client agent B 350. Initially, the client agent A 340 is installed on the virtual machine 270, while the client agent B 350 is installed on the resource 375. By way of example, the client agent A 340 may sit in a network protocol stack on a particular machine, such as a physical processor within the data center 225. In this example, the client agent A 340 is an application that is installed in the network protocol stack in order to facilitate receiving and sending communications to and from the endpoint A 395.

In operation, the client agents A 340 and B 350 negotiate with the hosting name server 310 to access identities and addresses of endpoints that participate in the service application. For instance, upon the endpoint A 395 sending a communication over the secured connection 335 to the virtual presence B′ 332 in the overlay 330, the client agent A 340 coordinates with the hosting name server 310 to retrieve the physical IP address of the virtual presence B′ 332 from the map 320. Typically, there is a one-to-one mapping between the physical IP address of the endpoint B 385 and the corresponding virtual IP address of the virtual presence B′ 332 within the map 320. In other embodiments, a single endpoint may have a plurality of virtual presences.

Once the physical IP address of the endpoint B 385 is attained by the client agent A 340 (acquiring address resolution from the hosting name server 310), the client agent A 340 automatically instructs one or more transport technologies to convey the packet 316 to the physical IP address of the endpoint B 385. These transport technologies may include drivers deployed at the virtual machine 270, a virtual private network (VPN), an internet relay, or any other mechanism that is capable of delivering the packet 316 to the physical IP address of the endpoint B 385 across the network 315 of the physical network 380. As such, the transport technologies employed by the client agents A 340 and B 350 can interpret the IP-level, peer-to-peer semantics of communications sent across the secured connection 335 and can guide a packet stream that originates from a source endpoint (e.g., endpoint A 395) to a destination endpoint (e.g., endpoint B 385) based on those communications. Although a physical IP address has been described as a means for locating the endpoint B 385 within the physical network 380, it should be understood and appreciated that other types of suitable indicators or physical IP parameters that locate the endpoint B 385 in the enterprise private network 325 may be used, and that embodiments of the present invention are not limited to those physical IP addresses described herein.

In another embodiment, the transport mechanism is embodied as a network address translation (NAT) device. Initially, the NAT device resides at a boundary of a network in which one or more endpoints reside. The NAT device is generally configured to present a virtual IP address of those endpoints to other endpoints in the group that reside in another network. In operation, with reference to FIG. 3, the NAT device presents the virtual IP address of the virtual presence B′ 332 to the endpoint A 395 when the endpoint A 395 is attempting to convey information to the endpoint B 385. At this point, the virtual presence A′ 331 can send a packet stream addressed to the virtual IP address of the virtual presence B′ 332. The NAT device accepts the streaming packets, and changes the headers therein from the virtual IP address of the virtual presence B′ 332 to its physical IP address. Then the NAT device forwards the streaming packets with the updated headers to the endpoint B 385 within the enterprise private network 325.

As discussed above, this embodiment that utilizes the NAT device instead of, or in concert with, the map 320 to establish underlying network connectivity between endpoints represents an distinct example of a mechanism to support or replace the map 320, but is not required to implement the exemplary embodiments of the invention described herein.

In yet another embodiment of the transport mechanism, reachability between the endpoints A 395 and B 385 can be established across network boundaries via a rendezvous point that resides on the public Internet. The “rendezvous point” generally acts as a virtual routing bridge between the resource 375 in the private enterprise network 325 and the data center 225 in the cloud computing platform 200. In this embodiment, connectivity across the virtual routing bridge is involves providing the rendezvous point with access to the map 320 such that the rendezvous point is equipped to route the packet 316 to the proper destination within the physical network 380.

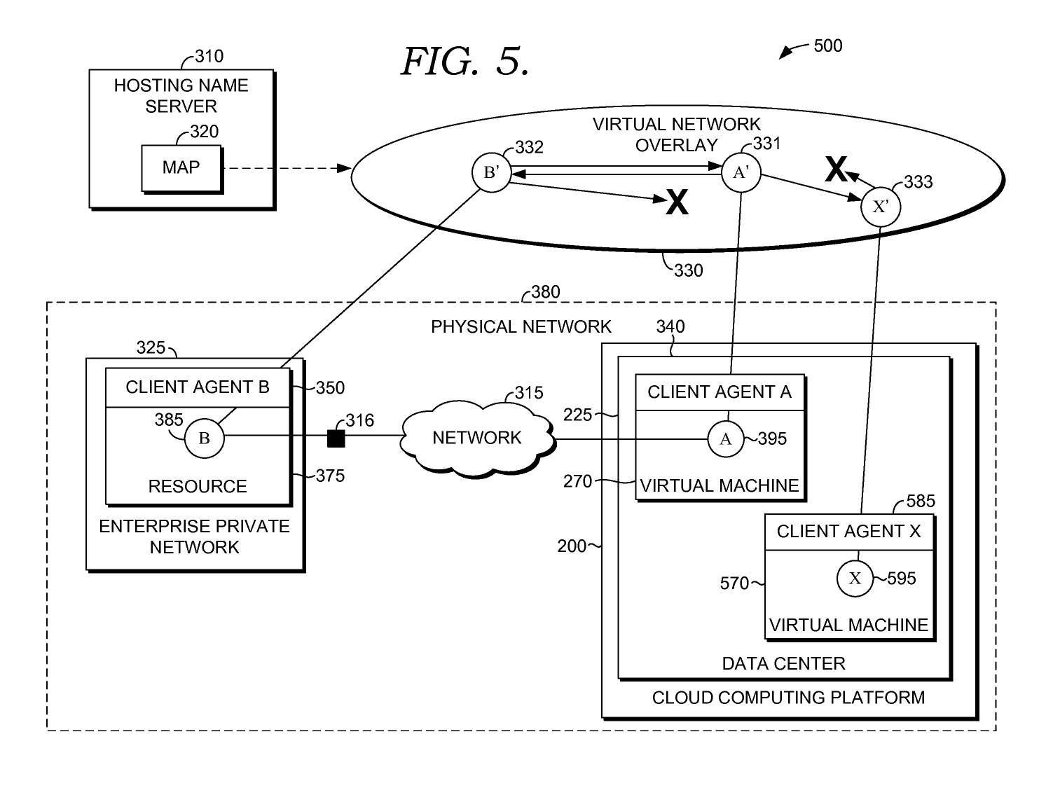

In embodiments, polices may be provided by the customer, the service application owned by the customer, or the service model associated with the service application. These policies will now be discussed with reference to FIG. 5. Generally, FIG. 5 depicts a block diagram of exemplary distributed computing environment 500 with the overlay 330 established therein, in accordance with an embodiment of the present invention.

Within the overlay 330 there are three virtual presences A′ 331, B′ 332, and X′ 333. As discussed above, the virtual presence A′ 331 is a representation of the endpoint A 395 instantiated on the overlay 330, while the virtual presence B′ 332 is a representation of the endpoint B 385 instantiated on the overlay 330. The virtual presence X′ is a representation of an endpoint X 595, residing in a virtual machine 570 hosted and supported by the data center 225, instantiated on the overlay 330. In one embodiment, the endpoint X 595 is recently joined to the group of endpoints associated with the service application. The endpoint X 595 may have been invoked to join the group of endpoints by any number of triggers, including a request from the service application or a detection that more components are required to participate in the service application (e.g., due to increased demand on the service application). Upon endpoint X 595 joining to the group of endpoints, a physical IP address of the endpoint X 595 is automatically bound and maintained in association with a virtual IP address of the virtual presence X′ 333. In an exemplary embodiment, a virtual IP address of the virtual presence X′ 333 is selected from the same range of virtual IP addresses as the virtual IP addresses selected for the virtual presences A′ 331 and B′ 332. Further, the virtual IP addresses assigned to the virtual presences A′ 331 and B′ 332 may distinct from the virtual IP address assigned to the virtual presence X′ 333. By way of example, the distinction between the virtual IP addresses is in the value of the specific address assigned to virtual presences A′ 331, B′ 332, and X′ 333, while the virtual IP addresses are each selected from the same range, as discussed in more detail below, and are each managed by the map 320.

Although endpoints that are not joined as members of the group of endpoints cannot communicate to the endpoints A 395, B 385, and X 595, by virtue of the configuration of the overlay 330, the policies are implemented to govern how the endpoints A 395, B 385, and X 595 communicate with one another, as well as with others in the group of endpoints. In embodiments, the policies include end-to-end rules that control the relationship among the endpoints in the group. By way of example, the end-to-end rules in the overlay 330 allow communication between the endpoints A 395 and B 385 and allow communication from the endpoint A 395 to the endpoint X 595. Meanwhile, the exemplary end-to-end rules in the overlay 330 prohibit communication from the endpoint B 385 to the endpoint X 595 and prohibit communication from the endpoint X 595 to the endpoint A 395. As can be seen, the end-to-end rules can govern the relationship between the endpoints in a group regardless of their location in the network 315 of the underlying physical network 380. By way of example, the end-to-end rules comprise provisioning IPsec policies, which achieve enforcement of the end-to-end rules by authenticating an identity of a source endpoint that initiates the communication to the destination endpoint. Authenticating the identity may involve accessing and reading the map 320 within the hosting name server 310 to verify that a physical IP address of the source endpoint corresponds with a virtual IP address that is pre-authorized to communicate over the overlay 330.

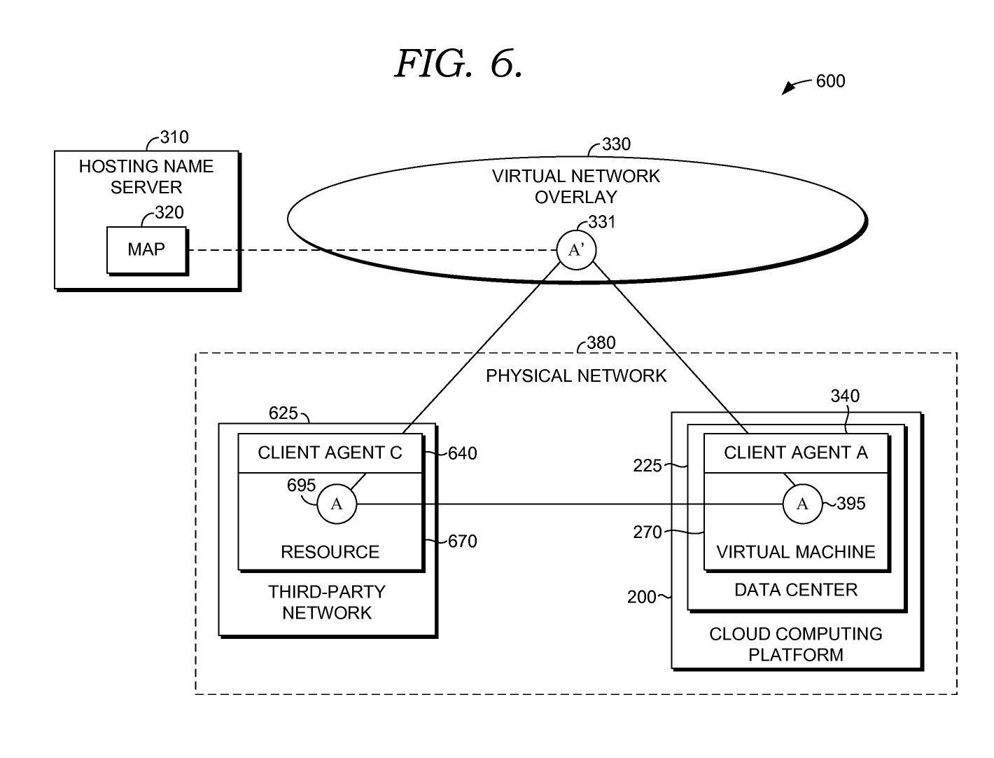

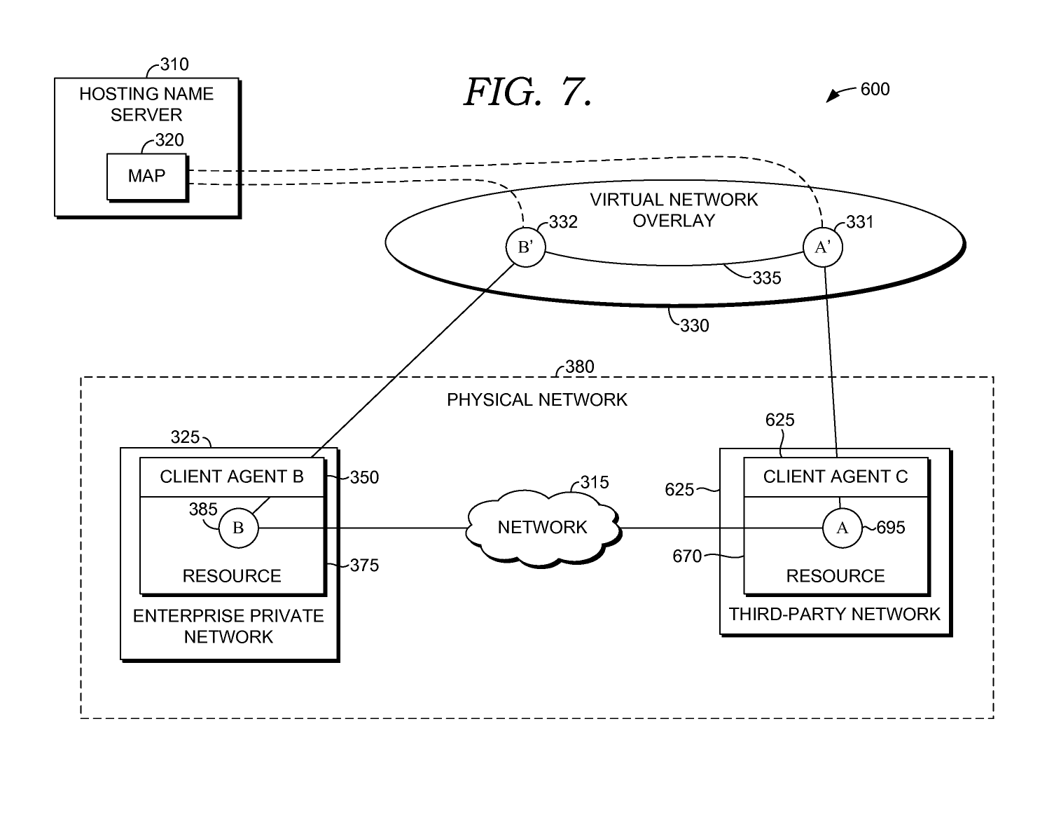

A process for moving an endpoint within a physical network will now be discussed with reference to FIGS. 6 and 7. As shown, FIGS. 6 and 7 depict a block diagram of exemplary distributed computing environment 600 with the overlay 330 established therein, in accordance with an embodiment of the present invention. Initially, upon the occurrence of some event, the endpoint A 395 is moved from the data center 225 within the cloud computing platform 200 to a resource 670 within a third-party network 625. Generally, the third-party network 625 may refer to any other network that is not the enterprise private network 325 of FIG. 3 or the cloud computing platform 200. By way of example, the third-party network 625 may include a data store that holds information used by the service application, or a vendor that provides software to support one or more operations of the service application.

In embodiments, the address of the endpoint 395 in the physical network 380 is changed from the physical IP address on the virtual machine 270 to a remote physical IP address on the third-party network 625. For instance, the event that causes the move may be a reallocation of resources controlled by the service application, a change in the data center 225 that prevents the virtual machine 270 from being presently available, or any other reason for switching physical hosting devices that support operations of a component of the service model.

The third-party network 625 represents a network of resources, including the resource 670 with a client agent C 640 installed thereon, that is distinct from the cloud computing platform 200 of FIG. 6 and the enterprise private network 325 of FIG. 7. However, the process of moving the endpoint A 395 that is described herein can involve moving the endpoints 385 to the private enterprise network 325 or internally within the data center 225 without substantially varying the steps enumerated below. Once the endpoint A 395 is moved, the hosting name server 310 acquires the remote physical IP address of the moved endpoint A 395. The remote physical IP address is then automatically stored in association with the virtual IP address of the virtual presence A′ 331 of the endpoint A 395. For instance, the binding between the physical IP address and the virtual IP address of the virtual presence A′ 331 is broken, while a binding between the remote physical IP address and the same virtual IP address of the virtual presence A′ 331 is established. Accordingly, the virtual presence A′ 331 is dynamically maintained in the map 320, as are the secured connections between the virtual presence A′ 331 and other virtual presences in the overlay 330.

Further, upon exchanging communications over the secured connections, the client agent C 640 is adapted to cooperate with the hosting name server 310 to locate the endpoint A 395 within the third-party network 625. This feature of dynamically maintaining in the map 320 the virtual presence A′ 331 and its secured connections, such as the secured connection 335 to the virtual presence B′ 332, is illustrated in FIG. 7. In an exemplary embodiment, the movement of the endpoint A 395 is transparent to the client agent B 350, which facilitates communicating between the endpoint B 385 and the endpoint A 395 without any reconfiguration.

Turning now to FIG. 8, a schematic depiction is illustrated that shows a plurality of overlapping ranges II 820 and III 830 of physical IP addresses and a nonoverlapping range I 810 of virtual IP addresses, in accordance with an embodiment of the present invention. In embodiments, the range I 810 of virtual IP addresses corresponds to address space assigned to the overlay 330 of FIG. 7, while the overlapping ranges II 820 and III 830 of physical IP addresses correspond to the address spaces of enterprise private network 325 and the cloud computing platform 200 of FIG. 3. As illustrated, the ranges II 820 and III 830 of physical IP addresses may intersect at reference numeral 850 due to a limited amount of global address space available when provisioned with IP version 4 (IPv4) addresses. However, the range I 810 of virtual IP addresses is prevented from overlapping the ranges II 820 and III 830 of physical IP addresses in order to ensure the data packets and communications between endpoints in the group that is associated with the service application are not misdirected. Accordingly, a variety of schemes may be employed (e.g., utilizing the hosting name server 310 of FIG. 7) to implement the separation of and prohibit conflicts between the range I 810 of virtual IP addresses and the ranges II 820 and III 830 of physical IP addresses.

In one embodiment, the scheme may involve a routing solution of selecting the range I 810 of virtual IP addresses from a set of public IP addresses that are not commonly used for physical IP addresses within private networks. By carving out a set of public IP addresses for use a virtual IP address, it will be unlikely that the private IP addresses that are typically used as physical IP addresses will be duplicative of the virtual IP addresses. In other words, the public IP addresses, which may be called via a public Internet, are consistently different than the physical IP addresses used by the private networks, which cannot be called from a public Internet because no path exists. Accordingly, the public IP addresses are reserved for linking local addresses and not originally intended for global communication. By way of example, the public IP addresses may be identified by a special IPv4 prefix (e.g., 10.254.0.0/16) that is not used for private networks, such as the ranges II 820 and III 830 of physical IP addresses.

In another embodiment, IPv4 addresses that are unique to the range I 810 of virtual IP addresses, with respect to the ranges II 820 and III 830 of physical IP addresses, are dynamically negotiated (e.g., utilizing the hosting name server 310 of FIG. 3). In one instance, the dynamic negotiation includes employing a mechanism that negotiates an IPv4 address range that is unique in comparison to the enterprise private network 325 of FIG. 3 and the cloud computing platform 200 of FIG. 2 by communicating with both networks periodically. This scheme is based on the assumption that the ranges II 820 and III 830 of physical IP addresses are the only IP addresses used by the networks that host endpoints in the physical network 380 of FIG. 3. Accordingly, if another network, such as the third-party network 625 of FIG. 6, joins the physical network as an endpoint host, the IPv4 addresses within the range I 810 are dynamically negotiated again with consideration of the newly joined network to ensure that the IPv4 addresses in the range I 810 are unique against the IPv4 addresses that are allocated for physical IP addresses by the networks.

For IP version 6 (IPv6)-capable service applications, a set of IPv6 addresses that is globally unique is assigned to the range I 810 of virtual IP addresses. Because the number of available addresses within the IPv6 construct is very large, globally unique IPv6 addresses may be formed by using the IPv6 prefix assigned the range I 810 of virtual IP addresses without the need to set up a scheme to ensure there are no conflicts with the ranges II 820 and III 830 of physical IP addresses.

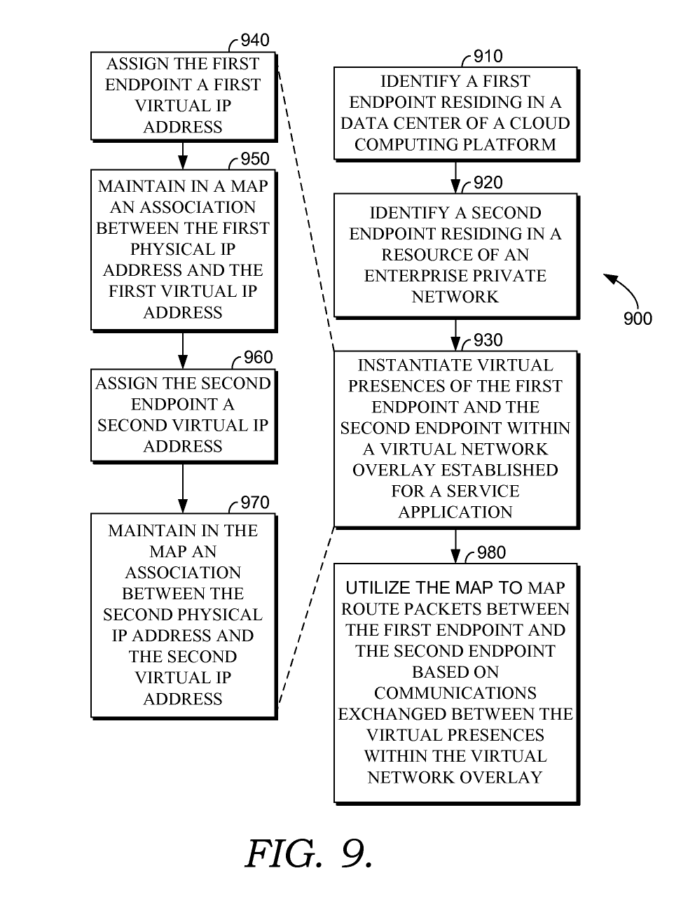

Turning now to FIG. 9, a flow diagram is illustrated that shows a method 900 for communicating across the overlay between a plurality of endpoints residing in distinct locations within a physical network, in accordance with an embodiment of the present invention. The method 900 involves identifying a first endpoint residing in a data center of a cloud computing platform (e.g., utilizing the data center 225 of the cloud computing platform 200 of FIGS. 2 and 3) and identifying a second endpoint residing in a resource of an enterprise private network (e.g., utilizing the resource 375 of the enterprise private network 325 of FIG. 3). These steps are indicated at blocks 910 and 920. In embodiments, the first endpoint is reachable by a packet of data at a first physical IP address, while the second endpoint is reachable at a second physical IP address. The method 900 may further involve instantiating virtual presences of the first endpoint and the second endpoint within the overlay (e.g., utilizing the overlay 330 of FIGS. 3 and 5-7) established for a particular service application, as indicated at block 930.

In an exemplary embodiment, instantiating includes one or more of the following steps: assigning the first endpoint a first virtual IP address (see block 940) and maintaining in a map an association between the first physical IP address and the first virtual IP address (see block 950). Further, instantiating may include assigning the second endpoint a second virtual IP address (see block 960) and maintaining in the map an association between the second physical IP address and the second virtual IP address (see block 970). In operation, the map (e.g., utilizing the map 320 of FIG. 3) may be employed to route packets between the first endpoint and the second endpoint based on communications exchanged between the virtual presences within the overlay. This step is indicated at block 980.

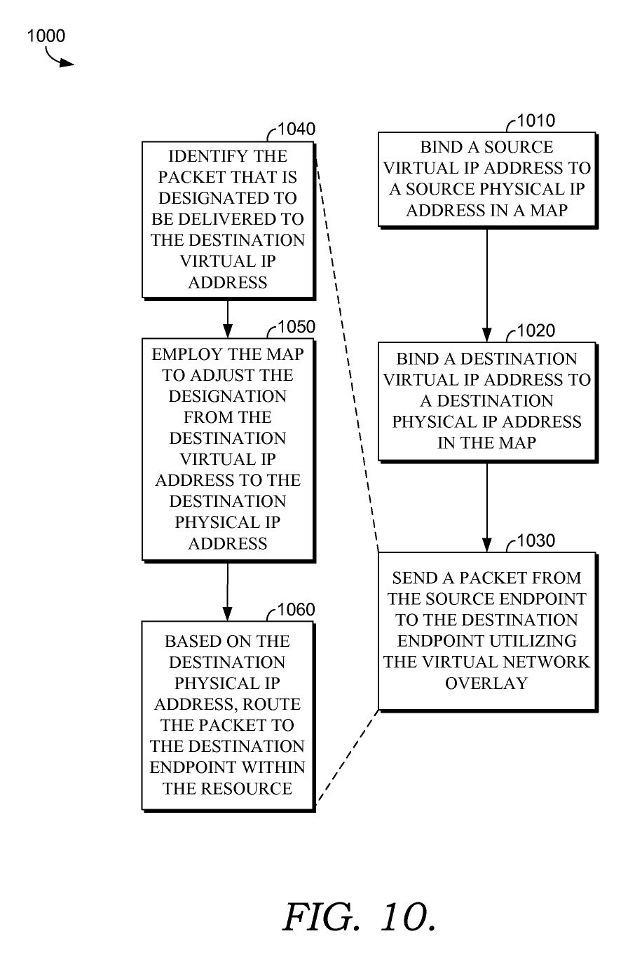

Referring now to FIG. 10, a flow diagram is illustrated that shows a method 1000 for facilitating communication between a source endpoint and a destination endpoint across the overlay, in accordance with an embodiment of the present invention. In one embodiment, the method 1000 involves binding a source virtual IP address to a source physical IP address (e.g., IPA 410 and IPA′ 405 of FIG. 4) in a map and binding a destination virtual IP address to a destination physical IP address (e.g., IPB 430 and IPB′ 425 of FIG. 4) in the map. These steps are indicated at blocks 1010 and 1020. Typically, the source physical IP address indicates a location of the source endpoint within a data center of a cloud computing platform, while the destination physical IP address indicates a location of the destination endpoint within a resource of an enterprise private network.

The method 1000 may further involve sending a packet from the source endpoint to the destination endpoint utilizing the overlay, as indicated at block 1030. Generally, the source virtual IP address and the destination virtual IP address indicate a virtual presence of the source endpoint and the destination endpoint, respectively, in the overlay. In an exemplary embodiment, sending the packet includes one or more of the following steps: identifying the packet that is designated to be delivered to the destination virtual IP address (see block 1040); employing the map to adjust the designation from the destination virtual IP address to the destination physical IP address (see block 1050); and based on the destination physical IP address, routing the packet to the destination endpoint within the resource (see block 1060).

Embodiments of the present invention have been described in relation to particular embodiments, which are intended in all respects to be illustrative rather than restrictive. Alternative embodiments will become apparent to those of ordinary skill in the art to which embodiments of the present invention pertain without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for communicating across a virtual network overlay between a plurality of endpoints residing in distinct locations within a physical network, the method comprising:
identifying a first endpoint residing in a data center of a cloud computing platform, wherein the first endpoint is reachable by a first physical internet protocol (IP) address;
identifying a second endpoint residing in a resource of an enterprise private network, wherein the second endpoint is reachable by a second physical IP address; and
instantiating virtual presences of the first endpoint and the second endpoint within the virtual network overlay established for a service application, wherein instantiating comprises:
(a) assigning the first endpoint a first virtual IP address;
(b) maintaining in a map an association between the first physical IP address and the first virtual IP address;
(c) assigning the second endpoint a second virtual IP address; and
(d) maintaining in the map an association between the second physical IP address and the second virtual IP address, wherein the map instructs where to route packets between the first endpoint and the second endpoint based on communications exchanged within the virtual network overlay.

2. The one or more computer-readable media of claim 1, wherein identifying a first endpoint comprises:
inspecting a service model associated with the service application, wherein the service model governs which virtual machines are allocated to support operations of the service application;
allocating a virtual machine within the data center of the cloud computing platform in accordance with the service model; and
deploying the first endpoint on the virtual machine.

3. The one or more computer-readable media of claim 1, the method further comprising assigning the virtual network overlay a range of virtual IP addresses, wherein the first virtual IP address and the second virtual IP address are selected from the assigned range.

4. The one or more computer-readable media of claim 3, wherein the virtual IP addresses in the range do not overlap physical IP addresses in ranges utilized by either the cloud computing platform or the enterprise private network.

5. The one or more computer-readable media of claim 3, wherein, when the enterprise private network is provisioned with IP version 4 (IPv4) addresses, the range of virtual IP addresses corresponds to a set of public IP addresses carved out of the IPv4 addresses.

6. The one or more computer-readable media of claim 1, the method further comprising:
joining the first endpoint and the second endpoint as members of a group that supports operations of a service application; and
instantiating a virtual presence of the members of the group within the virtual network overlay established for the service application.

7. A computer system for instantiating in a virtual network overlay a virtual presence of a candidate endpoint residing in a physical network, the computer system comprising:
a data center within a cloud computing platform that hosts the candidate endpoint having a physical IP address; and
a hosting name server that identifies a range of virtual IP addresses assigned to the virtual network overlay, that assigns to the candidate endpoint a virtual IP address that is selected from the range, and that maintains in a map the assigned virtual IP address in association with the physical IP address of the candidate endpoint.

8. The computer system of claim 7, wherein the hosting name server accesses the map for ascertaining identities of a group of endpoints employed by a service application to support operations thereof.

9. The computer system of claim 7, wherein the hosting name server assigns to the candidate endpoint the virtual IP address upon receiving a request from a service application that the candidate endpoint join the group of endpoints.

10. The computer system of claim 7, wherein the data center includes a plurality of virtual machines that host the candidate endpoint, and wherein a client agent runs on one or more of the plurality of virtual machines.

11. The computer system of claim 7, wherein a client agent negotiates with the hosting name server to retrieve one or more of the identities of the group of endpoints upon the candidate endpoint initiating conveyance of a packet.

12. The computer system of claim 11, further comprising a resource within an enterprise private network that hosts a member endpoint having a physical IP address.

13. The computer system of claim 12, wherein the member endpoint is allocated as a member of the group of endpoints employed by a service application, wherein the member endpoint is assigned a virtual IP address that is selected from the range of virtual IP addresses, and wherein the virtual IP address assigned to the member endpoint is distinct from the virtual IP address assigned to the candidate endpoint.

14. The computer system of claim 13, wherein the virtual IP address assigned to the candidate endpoint is connected through the virtual network overlay to the virtual IP address assigned to the member endpoint.

15. The computer system of claim 14, wherein, upon the candidate endpoint sending a communication to the member endpoint across the connection, the client agent retrieves the physical IP address of the member endpoint from the hosting name server.

16. The computer system of claim 15, wherein the client agent utilizes the physical IP address of the member endpoint to route the packet through a topology of a physical network, wherein the physical network includes the cloud computing platform and the enterprise private network.

17. The computer system of claim 16, wherein the hosting name server is provisioned with end-to-end rules that govern relationships between members of the group of endpoints, wherein the end-to-end rules selectively restrict connectivity of the candidate endpoint to the members of the group of endpoints through the virtual network overlay.

18. A computerized method for facilitating communication between a source endpoint and a destination endpoint across a virtual network overlay, the method comprising:
binding a source virtual IP address to a source physical IP address in a map, wherein the source physical IP address indicates a location of the source endpoint within a data center of a cloud computing platform;
binding a destination virtual IP address to a destination physical IP address in the map, wherein the destination physical IP address indicates a location of the destination endpoint within a resource of an enterprise private network;
sending a packet from the source endpoint to the destination endpoint utilizing the virtual network overlay, wherein the source virtual IP address and the destination virtual IP address indicate a virtual presence of the source endpoint and the destination endpoint, respectively, in the virtual network overlay, and wherein sending the packet comprises:
(a) identifying the packet that is designated to be delivered to the destination virtual IP address;
(b) employing the map to adjust the designation from the destination virtual IP address to the destination physical IP address; and
(c) based on the destination physical IP address, routing the packet to the destination endpoint within the resource.

19. The computerized method of claim 18, further comprising:
moving the source endpoint from the data center of the cloud computing platform, having the source physical IP address, to a resource within a third-party network, having a remote physical address; and
automatically maintaining the virtual presence of the source endpoint in the virtual network overlay.

20. The computerized method of claim 18, further comprising, upon recognizing that the source endpoint has moved, automatically binding the source virtual IP address to the remote physical IP address in the map.
